(19) United States
(12) Patent Application Publication
(10) Pub. No.: US 2025/0153275 A1
(43) Pub. Date: May 15, 2025

(54) CLOSED-LOOP LASER-WELD ASSEMBLIES

(71) Applicant: GM Global Technology Operations LLC, Detroit, MI (US)

(72) Inventors: Huaxin Li, Rochester Hills, MI (US); Pankaj Kumar Jha, Troy, MI (US); Kaushik Kalita, Bengaluru (IN); Yi Liu, Troy, MI (US); Qigui Wang, Rochester Hills, MI (US); Lala Ram Patel, Bangalore (IN); Masoud MohammadPour, Novi, MI (US)

(21) Appl. No.: 18/505,600

(22) Filed: Nov. 9, 2023

(51) Int. Cl. B23K 26/26; F16B 5/08

(52) U.S. Cl. CPC B23K 26/26; F16B 5/08

(57) ABSTRACT

Systems, methods, and assemblies for forming or employing closed-loop laser-welds are described. Closed-loop laser-welds may be formed by, for example, actuating a laser on a substrate at a first point to initiate a weld and scanning the laser along a starting weld path, along a main weld path, and along an ending weld path. The starting weld path is from the first point to a second point. The main weld path is from the second point to a third point. The ending weld path is from the third point to a fourth point. The laser is scanned from the second point to the third point such that a bead of the main weld path defines an inner perimeter and an outer perimeter. The outer perimeter defines a closed-loop laser weld. The first point and the fourth points are within the inner perimeter.

### INTRODUCTION

The disclosure relates to the field of welding and, more specifically, to systems and methods for laser welding lap joints.

Laser lap welding is used in the automotive industry to join parts. Shapes of the laser welds include a line weld (e.g., a linear path), a “C” weld (e.g., an arcuate path forming a segment of a circle), and a staple weld (e.g., a linear path with a segment of a circle on both ends). While the staple weld is widely used, high stress raisers may compromise the strength of the weld. Therefore, there is a need in the art to reduce stress raisers experienced by the laser welds.

### SUMMARY

Systems, methods, and devices in accordance with the present disclosure provide laser welds having optimized stress risers using closed loops. In some aspects, the closed-loop laser welds optimize stress raisers using a symmetrical loading condition. In some additional or alternative aspects, the closed-loop laser welds optimize stress raisers by placing an initiation point and a conclusion point of the laser weld within a perimeter formed by the bead of the closed-loop laser weld. In some examples, maximum principal stress of closed-loop laser lap welds is reduced by 20% as compared to similar non-closed-loop laser lap welds.

Beneficially, closed-loop laser welds in accordance with the present disclosure may optimize reliability and durability of laser lap joints. Additionally, the closed-loop laser welds may reduce welding steps needed to bond substrates, energy required to meet performance metrics for the weld joint, component density for welded components, combinations thereof, and the like.

According to aspects of the present disclosure, a method includes actuating a laser on a substrate at a first point to initiate a weld and scanning the laser along a starting weld path, along a main weld path, and along an ending weld path. The starting weld path is from the first point to a second point. The main weld path is from the second point to a third point. The ending weld path is from the third point to a fourth point. The laser is scanned from the second point to the third point such that a bead of the main weld path defines an inner perimeter and an outer perimeter. The outer perimeter defines a closed-loop laser weld. The first point and the fourth points are within the inner perimeter.

According to further aspects of the present disclosure, the closed-loop laser weld includes a first radiused portion opposite a second radiused portion and a first elongate portion opposite a second elongate portion. The first elongate portion connects a first end of the first radiused portion to a first end of the second radiused portion, and the second elongate portion connects a second end of the first radiused portion to a second end of the second radiused portion.

According to further aspects of the present disclosure, the first elongate portion defines a length between the first end of the first radiused portion and the first end of the second radiused portion. The first radiused portion defines a first radius, and a ratio of the length between the radiused portions to the first radius is between 2 and 10.

According to further aspects of the present disclosure, the first elongate portion defines a length between the first end of the first radiused portion and the first end of the second radiused portion and the first radiused portion defines a first radius. A ratio of the length to the first radius is between 2.5 and 4.

According to further aspects of the present disclosure, the first elongate portion defines a length between the first end of the first radiused portion and the first end of the second radiused portion and the first radiused portion defines a first radius. A ratio of the length to the first radius is between 2.5 and 3.2.

According to further aspects of the present disclosure, the second point and the third point lie on the first elongate portion.

According to further aspects of the present disclosure, the second point and the third point lie on the second elongate portion.

According to further aspects of the present disclosure, operating parameters for the laser include a first set of operating parameters for the starting weld path, a second set of operating parameters for the main weld path, and a third set of operating parameters for the ending weld path. The first set of operating parameters includes a ramp up from a first laser power to a second laser power. The second set of operating parameters includes the second laser power. The third set of operating parameters includes a ramp down from the second laser power to a third laser power.

According to further aspects of the present disclosure, the third laser power is lower than the first laser power.

According to aspects of the present disclosure, a closed-loop laser weld includes a first radiused portion opposite a second radiused portion, a first elongate portion opposite a second elongate portion, and a first terminal portion and a second terminal portion. A perimeter is formed by the first elongate portion connecting a first end of the first radiused portion to a first end of the second radiused portion and the second elongate portion connecting a second end of the first radiused portion to a second end of the second radiused portion. The first terminal portion and the second terminal portion are located within the perimeter. The closed-loop laser weld is formed by scanning a laser on a substrate sequentially through the first terminal portion, a first part of the first elongate portion, the first radiused portion, the second elongate portion, the second radiused portion, a second part of the first elongate portion, and the second terminal portion.

According to further aspects of the present disclosure, the first elongate portion defines a length between the first end of the first radiused portion and the first end of the second radiused portion and the first radiused portion defines a first radius. A ratio of the length to the first radius is between 2 and 10.

According to further aspects of the present disclosure, the first elongate portion defines a length between the first end of the first radiused portion and the first end of the second radiused portion and the first radiused portion defines a first radius. A ratio of the length to the first radius is between 2.5 and 4.

According to further aspects of the present disclosure, the first elongate portion defines a length between the first end of the first radiused portion and the first end of the second radiused portion and the first radiused portion defines a first radius. A ratio of the length to the first radius is between 2.5 and 3.2.

According to further aspects of the present disclosure, the first terminal portion, the first part of the first elongate portion, the second part of the first elongate portion, and the second terminal portion meet at an intersection.

According to further aspects of the present disclosure, scanning the laser on the substrate includes a first set of operating parameters for the first terminal portion, a second set of operating parameters for the first part of the first elongate portion, the first radiused portion, the second elongate portion, the second radiused portion, the second part of the first elongate portion, and a third set of operating parameters for the second terminal portion. The first set of operating parameters includes a ramp up from a first laser power to a second laser power. The second set of operating parameters includes the second laser power. The third set of operating parameters includes a ramp down from the second laser power to a third laser power.

According to further aspects of the present disclosure, the third laser power is lower than the first laser power.

According to aspects of the present disclosure, an assembly includes a first substrate, a second substrate, and a closed-loop laser weld bonding the first substrate to the second substrate. The closed-loop laser weld includes a first radiused portion opposite a second radiused portion, a first elongate portion opposite a second elongate portion, and a first terminal portion and a second terminal portion. A perimeter is formed by the first elongate portion connecting a first end of the first radiused portion to a first end of the second radiused portion and the second elongate portion connecting a second end of the first radiused portion to a second end of the second radiused portion. The first terminal portion and the second terminal portion are located within the perimeter. The closed-loop laser weld is formed by scanning a laser on a substrate sequentially through the first terminal portion, a first part of the first elongate portion, the first radiused portion, the second elongate portion, the second radiused portion, a second part of the first elongate portion, and the second terminal portion.

According to further aspects of the present disclosure, the assembly wherein the first elongate portion defines a length between the first end of the first radiused portion and the first end of the second radiused portion and the first radiused portion defines a first radius. A ratio of the length to the first radius is between 2.5 and 3.2

According to further aspects of the present disclosure, the assembly wherein the first terminal portion, the first part of the first elongate portion, the second part of the first elongate portion, and the second terminal portion meet at an intersection.

According to further aspects of the present disclosure, the assembly wherein scanning the laser on the substrate includes a first set of operating parameters for the first terminal portion, a second set of operating parameters for the first part of the first elongate portion, the first radiused portion, the second elongate portion, the second radiused portion, the second part of the first elongate portion, and a third set of operating parameters for the second terminal portion. The first set of operating parameters includes a ramp up from a first laser power to a second laser power. The second set of operating parameters includes the second laser power. The third set of operating parameters includes a ramp down from the second laser power to a third laser power.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

The drawings are illustrative and not intended to limit the subject matter defined by the claims. Exemplary aspects are discussed in the following detailed description and shown in the accompanying drawings in which:

FIG. 1 illustrates a schematic closed-loop laser weld, according to aspects of the present disclosure;

FIG. 2 illustrates a second schematic closed-loop laser weld, according to aspects of the present disclosure;

FIG. 3 illustrates an example weld path for forming closed-loop laser welds, according to aspects of the present disclosure;

FIG. 4 illustrates an assembly employing an example closed-loop laser weld, according to aspects of the present disclosure;

FIG. 5 illustrates a chart of simulation outcomes for the maximum stress of example welds in the assembly of FIG. 4;

FIG. 6 illustrates a section of a finite element analysis result for principal stress on an open-loop laser weld in the assembly of FIG. 4;

FIG. 7 illustrates a section of a finite element analysis result for principal stress on a first closed-loop laser weld in the assembly of FIG. 4, according to aspects of the present disclosure;

FIG. 8 illustrates a finite element analysis result for principal stress on a second closed-loop laser weld in the assembly of FIG. 4, according to aspects of the present disclosure;

FIG. 9 illustrates a finite element analysis result for principal stress on a third closed-loop laser weld in the assembly of FIG. 4, according to aspects of the present disclosure; and

FIG. 10 illustrates an example method of forming a closed-loop laser weld in the assembly of FIG. 4, according to aspects of the present disclosure.

### DETAILED DESCRIPTION

The following detailed description is merely exemplary in nature and is not intended to limit the application and uses. Furthermore, there is no intention to be bound by expressed or implied theory presented in the preceding introduction, summary, brief description of the drawings, or the following detailed description.

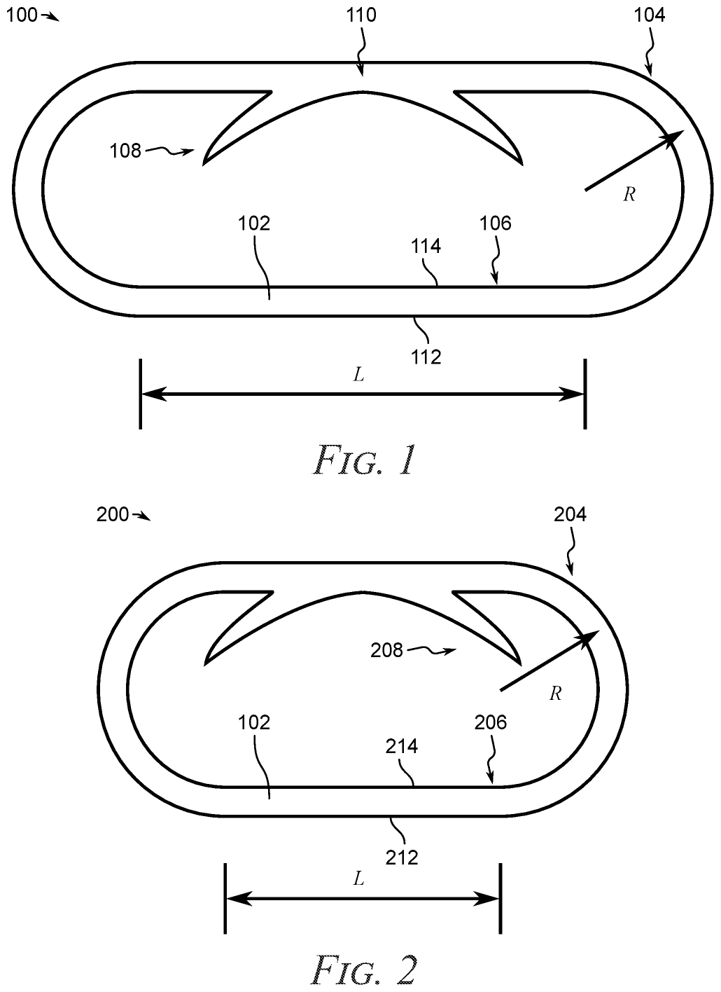

FIG. 1 illustrates a schematic closed-loop laser weld 100. The closed-loop laser weld 100 includes a bead 102 defining radiused portions 104, elongate portions 106, and terminal portions 108, with the terminal portions 108 and one of the elongate portions 106 meeting at an intersection 110. The bead 102 also defines an outer perimeter 112 and an inner perimeter 114. The radiused portions 104 have a radius R of curvature. The elongate portions 106 extend a length L between the radiused portions 104. The illustrated closed-loop laser weld 100 has a length L to radius R ratio of 4:1 (or simply 4).

The terminal portions 108 are disposed within an inner perimeter 114 of the closed-loop laser weld 100. Each of the terminal portions 108 is either a starting point or an ending point of the weld path. While not being bound by theory, it is believed that disposing the terminal portions 108 within the inner perimeter 114 of the closed-loop laser weld 100 optimizes strength of the closed-loop laser weld 100 by enhancing uniformity and control of properties for portions of the bead 102 exposed to or experiencing stress risers. For example, the closed-loop laser weld 100 reduces effects of weld defects associated with initiation and conclusion of the weld and asymmetric loading conditions on the bead 102.

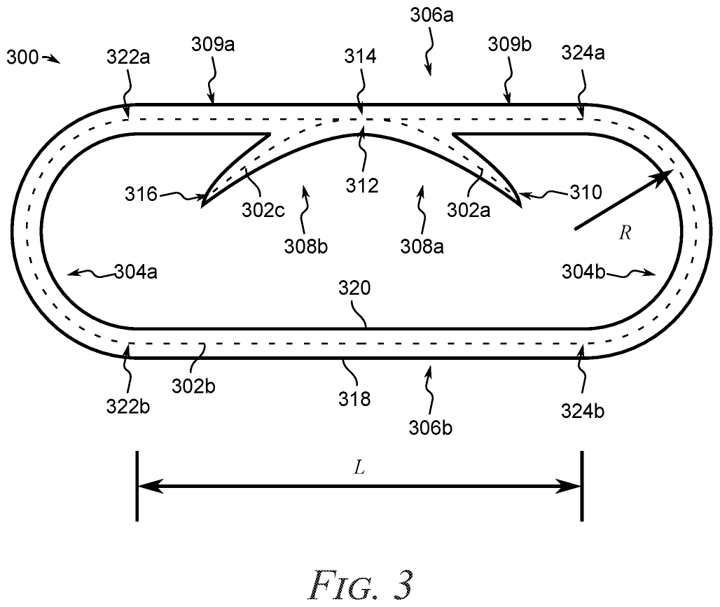

FIG. 2 illustrates a second schematic closed-loop laser weld 200. The closed-loop laser weld 200 includes a bead 202 defining radiused portions 204, elongate portions 206, and terminal portions 208, with the terminal portions 208 and one of the elongate portions 206 meeting at an intersection 210. The bead 202 also defines an outer perimeter 212 and an inner perimeter 214. The radiused portions 204 have a radius R of curvature. The elongate portions 206 have a length L extending between the radiused portions. The illustrated closed-loop laser weld 100 has a length L to radius R ratio of 2.5:1 (or simply 2.5).

The terminal portions 208 are disposed within an inner perimeter 214 of the closed-loop laser weld 200. Each of the terminal portions 208 is either a starting point or an ending point of the weld path. As can be seen, while the ratio of length L to radius R of the second closed-loop laser weld 200 has been reduced compared to that of the closed-loop laser weld 100 of FIG. 1, the sizing of the second terminal portions 208 may remain the same as the first terminal portions 108. In some aspects, the terminal portions are sized and/or shaped based on a width of the bead 102, 202.

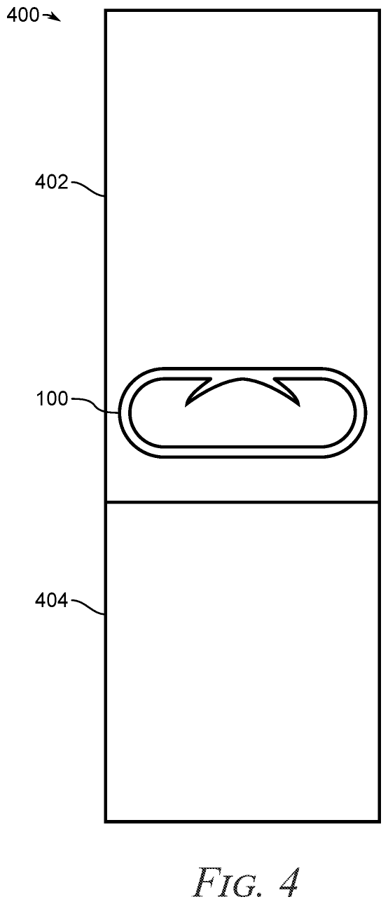

FIG. 3 illustrates an example weld path 300 for forming closed-loop laser welds. The weld path 300 includes a starting weld path 302a, a main weld path 302b, and an ending weld path 302c (collectively “weld path 302”). The starting weld path 302a follows a first terminal portion 308a and the ending weld path 302c follows a second terminal portion 308b.

The main weld path 302b forms a first radiused portion 304a opposite a second radiused portion 304b and a first elongate portion 306a opposite a second elongate portion 306b. The first elongate portion 306a connects a first end 322a of the first radiused portion 304a to a first end 324a of the second radiused portion 304b and the second elongate portion 306a connects a second end 322b of the first radiused portion 304a to a second end 324b of the second radiused portion 304b.

The main weld path is formed by scanning a laser on a substrate sequentially through the first terminal portion 308a, a first part 309a of the first elongate portion 306a, the first radiused portion 304a, the second elongate portion 306b, the second radiused portion 304b, a second part 309b of the first elongate portion 306a, and the second terminal portion 308b.

The laser is actuated a first point 310 on the substrate to initiate the weld and scanned along the starting weld path 302a from the first point 310 to a second point 312 to form a first terminal portion 308a. The laser is then scanned along the main weld path 302b from the second point 312 to a third point 314 such that a bead of the main weld path forms a closed-loop laser weld. After forming the closed-loop laser weld, the laser is scanned along the ending weld path 302a from the third point 314 to a fourth point 316 to form a second terminal portion 308b. The bead of the main weld path 302b defines an outer perimeter 318 and an inner perimeter 320. The first point 310 and the fourth point 316 are within the inner perimeter 320.

Each of the first radiused portion 304a and the second radiused portion 304b define a radius R. Each of the first elongate portion 306a and the second elongate portion 306b define a length L between the first radiused portion 304a and the second radiused portion 304b. In some aspects, the ratio of the length L to the radius R is between 2 and 10. In further aspects, the ratio of the length L to the radius R is between 2.5 and 4. In yet further aspects, the ratio of the length L to the radius R is between 2.5 and 3.2. Beneficially, as will be discussed with reference to FIG. 5, selection of the ratios may be made based on desired maximum principal stress experienced by the weld.

In the illustrated examples, the second point 312 and the third point 314 are co-located such that the starting weld path 302a, the main weld path 302b, and the ending weld path 302c have a common intersection (e.g., intersection 110 of FIG. 1). In some aspects, the third point 314 is located before the second point 312 and operating parameters of the laser are selected to provide adequate temperature and fluid flow to close the loop. In some aspects, the third point 314 is located after the second point 312 and parameters of the laser used between the second point 312 and third point 314 of each respective pass are selected to provide homogenous material properties of the bead along the main weld path 302b for both the single-pass portions and the overlapping portions.

Operating parameters for the laser may be continuous or may vary between one or more segments of the weld path 302 to achieve desired properties of the resulting bead 102. These parameters may include, for example, scan speeds, scan patterns, laser power, laser-power ramp profiles, laser pulse characteristics, combinations thereof, and the like.

If the parameters remain constant, material properties of the bead 102 may differ between the initiation of the starting weld path 302a (e.g., the first point 310), the main weld path 302b, and conclusion at the ending weld path 302c (e.g., the fourth point 316). For example, a temperature of the substrate, a heating profile, and an environment for forming the weld at the initiation spot will be different than those for forming the weld along the main weld path 302b and the ending weld path 302c. Further, a cooling profile and an environment for forming the weld at the conclusion spot will be different than those for forming the weld along the starting weld path 302a and the main weld path 302b. Beneficially, disposing the terminal portions 308 within the inner perimeter 320 as described herein enhances the resulting weld by reducing non-homogeneity of the bead 102 exposed to external stresses.

Moreover, disposing the terminal portions 308a, 308b within the inner perimeter 320 optimizes control of material of properties of the bead 102 to supplement or provide homogeneity along the main weld path 302b of the bead 102. For example, disposing the terminal portions 108 within the inner perimeter of the closed-loop laser weld 100 reduces coupling of the operational parameters used at the initiation point and the conclusion point of the weld from resulting stress risers that the bead 102 experiences.

In some aspects, the laser is operated at a first set of operating parameters for the starting weld path 302a, a second set of operating parameters for the main weld path 302b, and a third set of operating parameters for the ending weld path 302c. For example, the laser parameters for the starting weld path 302a may be selected to ramp up from a first, lower power setting to a second, higher power setting before the laser reaches the intersection 110 with the main weld path 302b (e.g., second point 312). The laser may then be operated at the second, higher power setting through the main weld path 302b until it reaches the intersection 110 a second time (e.g., third point 314), where it continues onto the ending weld path 302c. The laser parameters for the ending weld path 302c may be ramped down from the second, higher power setting to a third, lower power setting for the conclusion of the weld path 302. In some aspects, the third power setting is higher than the first power setting. In further aspects, the third power setting is lower than the first power setting.

Additionally, or alternatively, design features of the terminal portions 308 may be selected to enhance homogeneity of stress distribution of portions of the bead 102 corresponding to the main path 302b. For example, the initiation point (e.g., first point 310) and/or shape of the starting path 302a may be selected to reduce differential conditions between the intersection 110 and the remainder of the main path 302b at the beginning of laying down the bead 102. Similarly, the conclusion point (e.g., fourth point (and/or shape of the ending path 302c may selected to reduce differential conditions between the main path 302b and the intersection 110 and the ending of laying down the bead 102. While not being bound by theory, it is believed that the terminal portions 306 being symmetrical may further optimize stress properties on the bead 102.

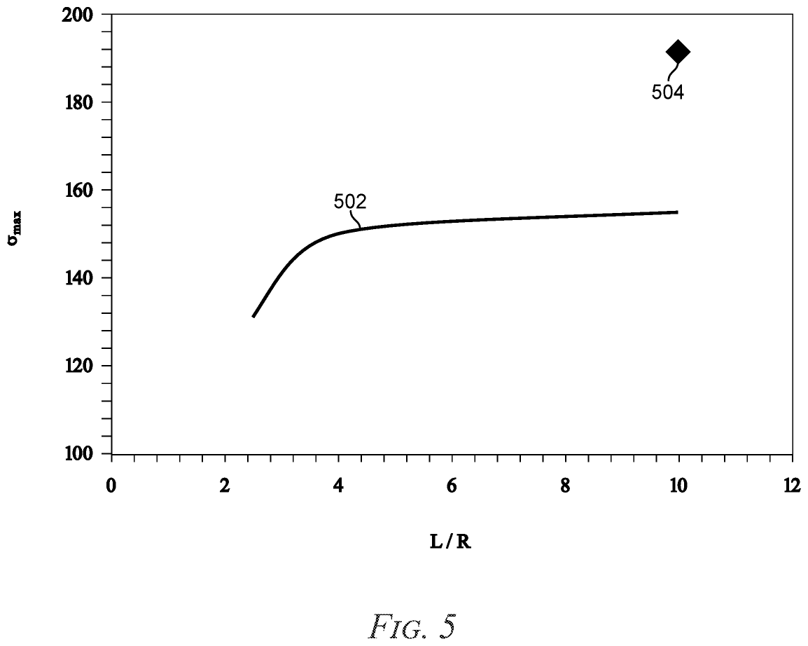

FIG. 4 illustrates an assembly 400 employing an example closed-loop laser weld 100. The closed-loop laser weld 100 bonds a first substrate 402 to a second substrate 404 to form the assembly 400. The substrates 402, 404 may be, for example, sheet metals.

FIG. 5 illustrates a chart of the maximum stress σₘₐₓ by ratio of length L to radius R for example welds in assembly 400. The chart includes a trendline 502 illustrating maximum stresses σₘₐₓ for closed-loop laser welds. As can be seen, the maximum stresses σₘₐₓ for the closed-loop laser welds increase more rapidly between ratios of about 2.5 and about 4 than it does between ratios of about 4 and about 10. While not being bound by theory, it is believed that reducing the ratio of length L to radius R increasingly optimizes stress experienced across the weld as the ratio approaches zero (e.g., a circle).

The chart also includes a point 504 illustrating the maximum stress for σₘₐₓ a staple weld. As can be seen, the maximum stress σₘₐₓ for the staple weld with a length L to radius R ratio of 10 is approximately 192 MPa while the maximum stress σₘₐₓ of a closed-loop laser weld having the same ratio of length L to radius R is about 20% lower at approximately 155 MPa.

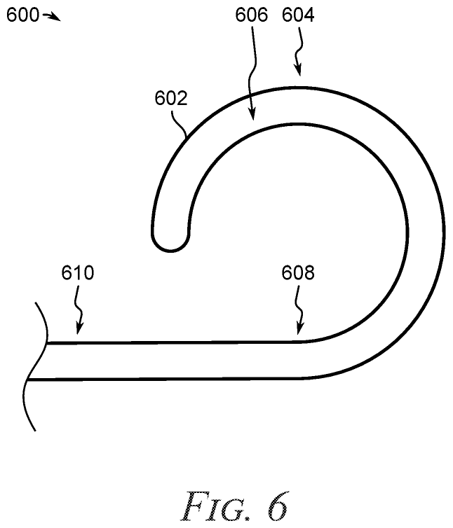

FIG. 6 illustrates a section of a finite element analysis result 600 of principal stress on an open-loop laser weld 602 having a staple configuration and a length L to radius R ratio of 10:1. Coach peel testing of the open-loop laser weld 602 was modeled in the configuration of FIG. 4. Each of the first sheet and the second sheet were 150 mm long and 50 mm wide. The first substrate and the second substrate overlapped by 40 mm. The open-loop laser weld 602 was centered within the overlapping area with a length L of 25 mm and radius R of 2.5 mm.

The maximum principal stress σₘₐₓ of the open-loop laser weld 602 was 191.7 MPa. The maximum principal stress σₘₐₓ of the open-loop laser weld 602 was located on the radiused portion of the staple approximately 180° away from the elongate portion at point 604 that is halfway through the thickness of the weld. The principal stress u declined uniformly from the maximum at the center of the thickness to a minimum at each of the surfaces 606.

The interior of the elongate portion of the open-loop laser weld 602 experienced a principal stress of approximately 72.3 MPa extending between point 608 at the end of the elongate portion and point 610 at the center of the elongate portion.

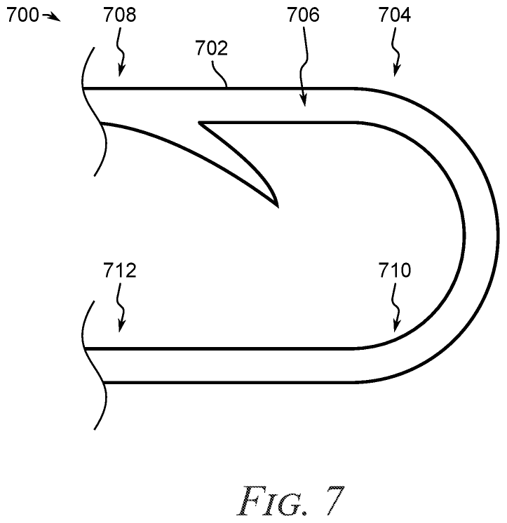

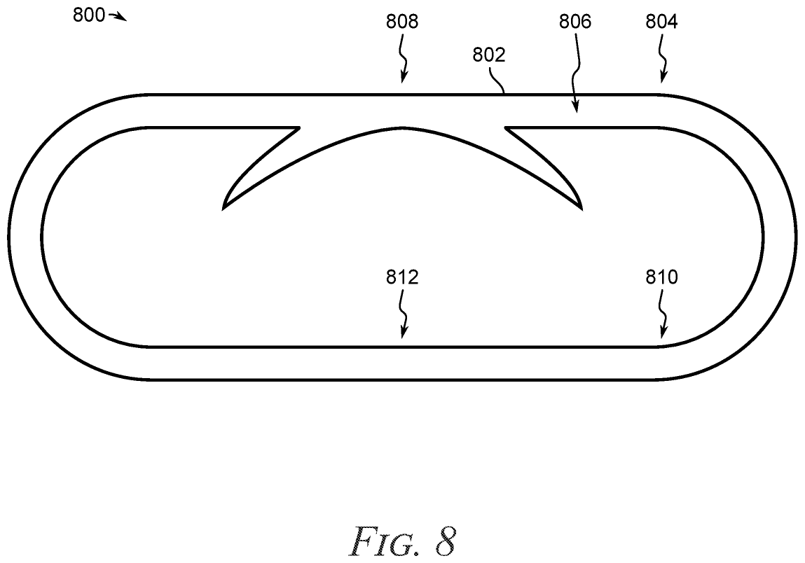

FIG. 7 illustrates a section of a finite element analysis result 700 of principal stress on a closed-loop laser weld 702 having a length L to radius R ratio of 10:1. Coach peel testing of the closed-loop laser weld 702 was modeled in the configuration of FIG. 4. Each of the first sheet and the second sheet were 150 mm long and 50 mm wide. The first substrate and the second substrate overlapped by 40 mm. The closed-loop laser weld 702 was centered within the overlapping area. The closed-loop laser weld 702 had a length L of 25 mm and radius R of 2.5 mm.

The maximum principal stress σₘₐₓ of the closed-loop laser weld 702 was 154.6 MPa. The maximum principal stress σₘₐₓ of the closed-loop laser weld 702 was located halfway through the thickness of the weld at the transition 704 from the elongate portion to the radiused portion on the side of the closed-loop laser weld 702 with terminal portions 308. The principal stress σ declined uniformly from the maximum at the center of the thickness to a minimum at each of the surfaces 706.

A point 708 proximate to the intersection 110 experienced a principal stress of approximately 119.4 MPa. The interior of the elongate portion opposite to the terminal portions 308 experienced a principal stress of approximately 57.8 MPa extending between point 710 at the end of the elongate portion and point 712 at the center of the elongate portion.

FIG. 8 illustrates a finite element analysis result 800 of principal stress on a closed-loop laser weld 802 having a length L to radius R ratio of 4:1. Coach peel testing of the closed-loop laser weld 802 was modeled in the configuration of FIG. 4. Each of the first sheet and the second sheet were 150 mm long and 50 mm wide. The first substrate and the second substrate overlapped by 40 mm. The closed-loop laser weld 802 was centered within the overlapping area. The closed-loop laser weld 802 had a length L of 10 mm and radius R of 2.5 mm.

The maximum principal stress σₘₐₓ of the closed-loop laser weld 802 was 149.5 MPa. The maximum principal stress σₘₐₓ of the closed-loop laser weld 802 was located halfway through the thickness of the weld at the transition 804 from the elongate portion to the radiused portion on the side of the closed-loop laser weld 802 with terminal portions 308. The principal stress σ declined uniformly from the maximum at the center of the thickness to a minimum at each of the surfaces 806.

A point 808 proximate to the intersection 110 experienced a principal stress of approximately 115.5 MPa. The interior of the elongate portion opposite to the terminal portions 308 experienced a principal stress of approximately 55.9 MPa extending between point 810 at the end of the elongate portion and point 812 at the center of the elongate portion.

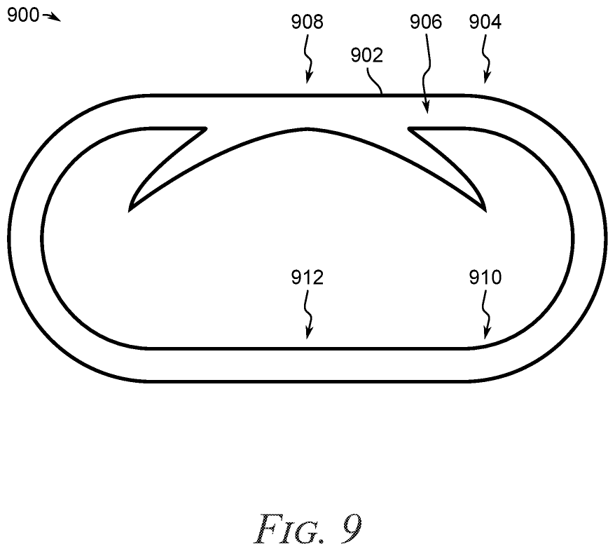

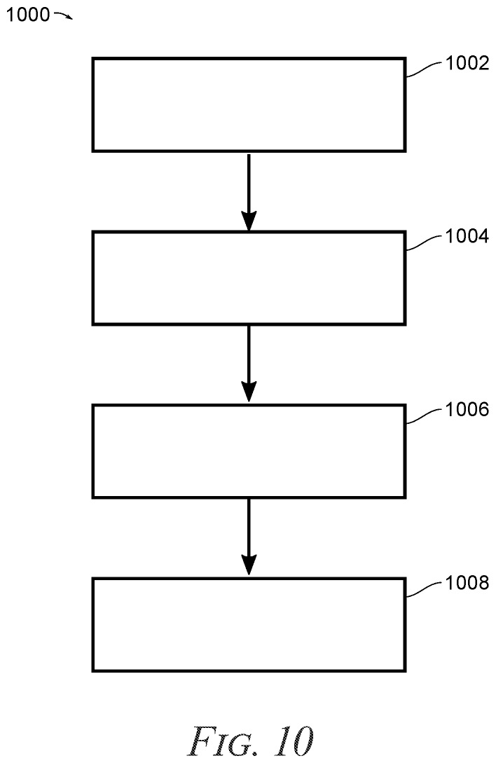

FIG. 9 illustrates a finite element analysis result 900 of principal stress on a closed-loop laser weld 902 having a length L to radius R ratio of 2.5:1. Coach peel testing of the closed-loop laser weld 902 was modeled in the configuration of FIG. 4. Each of the first sheet and the second sheet were 150 mm long and 50 mm wide. The first substrate and the second substrate overlapped by 40 mm. The closed-loop laser weld 902 was centered within the overlapping area. The closed-loop laser weld 902 had a length L of 6.25 mm and radius R of 2.5 mm.

The maximum principal stress σₘₐₓ of the closed-loop laser weld 902 was 132.0 MPa. The maximum principal stress σₘₐₓ of the closed-loop laser weld 902 was located halfway through the thickness of the weld at the transition 904 from the elongate portion to the radiused portion on the side of the closed-loop laser weld 902 with terminal portions 308. The principal stress σ declined uniformly from the maximum at the center of the thickness to a minimum at each of the surfaces 906.

A point 908 proximate to the intersection 110 experienced a principal stress of approximately 101.9 MPa. The interior of the elongate portion opposite to the terminal portions 308 experienced a principal stress of approximately 49.2 MPa extending between point 910 at the end of the elongate portion and point 912 at the center of the elongate portion.

FIG. 10 illustrates an example method 1000 of forming a closed-loop laser weld. The method 1000 begins at block 1002 by actuating the laser on the substrate at a first point to initiate a weld. The substrate may be, for example, the first substrate 402 or the second substrate 404. At block 1004, the laser is scanned along a starting weld path from the first point to a second point. At block 1006, the laser is scanned along a main weld path from the second point to a third point such that a bead of the main weld path defines an inner perimeter and an outer perimeter. The first point is within the inner perimeter, and the outer perimeter defines a closed-loop laser weld. At block 1008, the laser is scanned along an ending weld path from the third point to a fourth point with the fourth point being inside the inner perimeter.

While elongate portions are illustrated as linear segments, it is contemplated that other configurations, such as curvilinear segments, may be used. Further, while the terminal portions are illustrated as symmetric, it is contemplated that they may be asymmetrical. Moreover, while the intersection 110 is illustrated generally as a point, it is contemplated that a longer overlapping portion may be used.

While the weld path 302 is illustrated and described as a straight scan path, it is contemplated that other patterns or combinations thereof may be used (e.g., sinusoidal or cycloid scan paths).

While the described aspects reference laser welding, it is contemplated that other welding methods may be used. For example, the closed-loop laser weld 100 may be used in resistance welding and electron beam welding.

Embodiments of the present disclosure may be described herein in terms of functional and/or logical block components and various processing steps. It should be appreciated that such block components may be realized by one or more hardware, software, and/or firmware components configured to perform the specified functions. For example, embodiments of the present disclosure may employ various integrated circuit components (e.g., memory elements, digital signal processing elements, logic elements, look-up tables, or the like), which may carry out a variety of functions under the control of one or more microprocessors or other control devices. In addition, those skilled in the art will appreciate that embodiments of the present disclosure may be practiced in conjunction with one or more systems, and that the systems described herein are merely exemplary embodiments of the present disclosure.

As understood by one of skill in the art, the present disclosure is susceptible to various modifications and alternative forms, and some representative embodiments have been shown by way of example in the drawings and described in detail above. It should be understood, however, that the novel aspects of this disclosure are not limited to the particular forms illustrated in the appended drawings. Rather, the disclosure is to cover modifications, equivalents, combinations, sub-combinations, permutations, groupings, and alternatives falling within the scope and spirit of the disclosure and as defined by the appended claims.

As used herein, unless the context clearly dictates otherwise: the words “and” and “or” shall be both conjunctive and disjunctive, unless the context clearly dictates otherwise; the word “all” means “any and all” the word “any” means “any and all”; the word “including” means “including without limitation”; and the singular forms “a”, “an”, and “the” includes the plural referents and vice versa.

Numerical values of parameters (e.g., of quantities or conditions) in this specification, unless otherwise indicated expressly or clearly in view of the context, including the appended claims, are to be understood as being modified by the term “about” whether or not “about” actually appears before the numerical value. The numerical parameters set forth herein and in the attached claims are approximations that may vary depending upon the desired properties sought to be obtained by the present disclosure. At the very least, and not as an attempt to limit the application of the doctrine of equivalents to the scope of the claims, each numerical parameter should at least be construed in view of the number of reported significant digits and by applying ordinary rounding techniques.

Words of approximation, such as “approximately,” “about,” “substantially,” and the like, may be used herein in the sense of “at, near, or nearly at,” “within 0-10% of,” or “within acceptable manufacturing tolerances,” or a logical combination thereof, for example.

While the metes and bounds of the term “about” are readily understood by one of ordinary skill in the art, the term “about” indicates that the stated numerical value or property allows imprecision. If the imprecision provided by “about” is not otherwise understood in the art with this ordinary meaning, then “about” indicates at least variations that may arise from ordinary methods of measuring and using such parameters. For example, if not otherwise understood in the art, the term “about” means within 10% (e.g., ±10%) of the stated value.

While the metes and bounds of the term “substantially” are readily understood by one of ordinary skill in the art, the term “substantially” indicates that the stated numerical value or property allows some imprecision. If the imprecision provided by “substantially” is not otherwise understood in the art with this ordinary meaning, then “substantially” indicates at least variations that may arise from manufacturing processes and measurement of such parameters. For example, if not otherwise understood in the art, the term “substantially” means within 5% (e.g., ±5%) of the stated value.

It is to be understood that the ranges provided herein include the stated range, subranges within the stated range, and each value within the stated range.

While the best modes for carrying out the disclosure have been described in detail, those familiar with the art to which this disclosure relates will recognize various alternative designs and embodiments for practicing the disclosure within the scope of the appended claims.

What is claimed is:

1. A method comprising:
actuating a laser on a substrate at a first point to initiate a weld; and
scanning the laser:
along a starting weld path from the first point to a second point;
along a main weld path from the second point to a third point such that a bead of the main weld path defines an inner perimeter and an outer perimeter, the first point being within the inner perimeter, the outer perimeter defining a closed-loop laser weld; and
along an ending weld path from the third point to a fourth point, the fourth point being within the inner perimeter.

2. The method of claim 1, wherein the closed-loop laser weld includes:
a first radiused portion opposite a second radiused portion; and
a first elongate portion opposite a second elongate portion, the first elongate portion connecting a first end of the first radiused portion to a first end of the second radiused portion, the second elongate portion connecting a second end of the first radiused portion to a second end of the second radiused portion.

3. The method of claim 2, wherein the first elongate portion defines a length between the first end of the first radiused portion and the first end of the second radiused portion and the first radiused portion defines a first radius, wherein a ratio of the length to the first radius is between 2 and 10.

4. The method of claim 2, wherein the first elongate portion defines a length between the first end of the first radiused portion and the first end of the second radiused portion and the first radiused portion defines a first radius, wherein a ratio of the length to the first radius is between 2.5 and 4.

5. The method of claim 2, wherein the first elongate portion defines a length between the first end of the first radiused portion and the first end of the second radiused portion and the first radiused portion defines a first radius, wherein a ratio of the length to the first radius is between 2.5 and 3.2.

6. The method of claim 5, wherein the second point and the third point are on the first elongate portion.

7. The method of claim 5, wherein the second point and the third point are on the second elongate portion.

8. The method of claim 1, wherein operating parameters for the laser include:
a first set of operating parameters for the starting weld path, the first set of operating parameters including a ramp up from a first laser power to a second laser power;
a second set of operating parameters for the main weld path, the second set of operating parameters including the second laser power; and
a third set of operating parameters for the ending weld path, the third set of operating parameters including a ramp down from the second laser power to a third laser power.

9. The method of claim 8, wherein the third laser power is lower than the first laser power.

10. A closed-loop laser weld comprising:
a first radiused portion opposite a second radiused portion;
a first elongate portion opposite a second elongate portion, the first elongate portion connecting a first end of the first radiused portion to a first end of the second radiused portion and the second elongate portion connecting a second end of the first radiused portion to a second end of the second radiused portion to thereby form a perimeter; and
a first terminal portion and a second terminal portion located within the perimeter,
wherein the closed-loop laser weld is formed by scanning a laser on a substrate sequentially through the first terminal portion, a first part of the first elongate portion, the first radiused portion, the second elongate portion, the second radiused portion, a second part of the first elongate portion, and the second terminal portion.

11. The closed-loop laser weld of claim 10, wherein the first elongate portion defines a length between the first end of the first radiused portion and the first end of the second radiused portion and the first radiused portion defines a first radius, wherein a ratio of the length to the first radius is between 2 and 10.

12. The closed-loop laser weld of claim 10, wherein the first elongate portion defines a length between the first end of the first radiused portion and the first end of the second radiused portion and the first radiused portion defines a first radius, wherein a ratio of the length to the first radius is between 2.5 and 4.

13. The closed-loop laser weld of claim 10, wherein the first elongate portion defines a length between the first end of the first radiused portion and the first end of the second radiused portion and the first radiused portion defines a first radius, wherein a ratio of the length to the first radius is between 2.5 and 3.2.

14. The closed-loop laser weld of claim 10, wherein the first terminal portion, the first part of the first elongate portion, the second part of the first elongate portion, and the second terminal portion meet at an intersection.

15. The closed-loop laser weld of claim 10, wherein scanning the laser on the substrate includes:
a first set of operating parameters for the first terminal portion, the first set of operating parameters including a ramp up from a first laser power to a second laser power;
a second set of operating parameters for the first part of the first elongate portion, the first radiused portion, the second elongate portion, the second radiused portion, the second part of the first elongate portion, the second set of operating parameters including the second laser power; and
a third set of operating parameters for the second terminal portion, the third set of operating parameters including a ramp down from the second laser power to a third laser power.

16. The closed-loop laser weld of claim 15, further comprising:
wherein the third laser power is lower than the first laser power.

17. An assembly comprising:
a first substrate;
a second substrate; and
a closed-loop laser weld bonding the first substrate to the second substrate, the closed-loop laser weld including:
a first radiused portion opposite a second radiused portion;
a first elongate portion opposite a second elongate portion, the first elongate portion connecting a first end of the first radiused portion to a first end of the second radiused portion and the second elongate portion connecting a second end of the first radiused portion to a second end of the second radiused portion to thereby form a perimeter; and
a first terminal portion and a second terminal portion located within the perimeter,
wherein the closed-loop laser weld is formed by scanning a laser on a substrate sequentially through the first terminal portion, a first part of the first elongate portion, the first radiused portion, the second elongate portion, the second radiused portion, a second part of the first elongate portion, and the second terminal portion.

18. The assembly of claim 17, wherein the first elongate portion defines a length between the first end of the first radiused portion and the first end of the second radiused portion and the first radiused portion defines a first radius, wherein a ratio of the length to the first radius is between 2.5 and 3.2.

19. The assembly of claim 17, wherein the first terminal portion, the first part of the first elongate portion, the second part of the first elongate portion, and the second terminal portion meet at an intersection.

20. The assembly of claim 17, wherein scanning the laser on the substrate includes:
a first set of operating parameters for the first terminal portion, the first set of operating parameters including a ramp up from a first laser power to a second laser power;
a second set of operating parameters for the first part of the first elongate portion, the first radiused portion, the second elongate portion, the second radiused portion, the second part of the first elongate portion, the second set of operating parameters including the second laser power; and
a third set of operating parameters for the second terminal portion, the third set of operating parameters including a ramp down from the second laser power to a third laser power.
